(19) United States
(12) Patent Application Publication
(10) Pub. No.: US 2013/0065448 A1
(43) Pub. Date: Mar. 14, 2013

(54) ELECTRONIC CONNECTOR

(71) Applicants: SHYH-CHANG CHIU, Taipei City (TW); Hsuan-Ho Chung, Bade City (TW)

(72) Inventors: SHYH-CHANG CHIU, Taipei City (TW); Hsuan-Ho Chung, Bade City (TW)

(21) Appl. No.: 13/228,465

(22) Filed: Sep. 9, 2011

(51) Int. Cl. H01R 24/00

(52) U.S. Cl. 439/660

(57) ABSTRACT

An electronic connector comprises a housing and a printed circuit board. The housing defines an opening therein. The printed circuit board is mounted in the housing. The printed circuit board has a front portion located within the opening of the housing and a rear portion attached to the housing. A USB3.0 port interface and an eSATA port interface are provided at the front portion of the printed circuit board. A terminal section is provided at the rear portion of the printed circuit board. The terminal section includes a plurality of connecting pads. The two interfaces are electrically connected with the connecting pads via a plurality of conducting traces. Thereby, the USB port interface or the eSATA port interface can be individually selected for data transmission, and electrical coupling between differential signal pairs can be reduced.

### TECHNICAL FIELD OF THE INVENTION

The present invention relates to an electronic connector and, more particularly, to an electronic connector with a USB3.0 port interface and an eSATA port interface.

### DESCRIPTION OF THE PRIOR ART

To achieve the transmission of information between a computer and an external device, the computer and the external device should be provided with connectors, which can be implemented with various protocols. Currently, USB connectors and eSATA connectors are popular for data transmission between computers and external devices. Generally, these two kinds of connectors are manufactured separately. For example, a laptop computer may include multiple USB connectors and an eSATA connector to facilitate data transmission. However, such arrangement of connectors will increase the space requirement for laptop computers, thereby increasing the manufacturing cost.

Thus, there is a need to combine a USB connector and an eSATA connector to a compact form to satisfy the requirement of data transmission and reduce the space requirement for the connectors.

### SUMMARY OF THE INVENTION

The primary object of the present invention is to provide an electronic connector with a USB3.0 port interface and an eSATA port interface, whereby the USB port interface or the eSATA port interface can be individually selected for data transmission, and electrical coupling between differential signal pairs can be reduced.

To achieve the above object, the electronic connector comprises a housing and a printed circuit board. The housing defines an opening therein. The printed circuit board is mounted in the housing. The printed circuit board has a front portion located within the opening of the housing and a rear portion attached to the housing. A USB3.0 port interface and an eSATA port interface are provided at the front portion of the printed circuit board, the USB3.0 port interface being located on a first outside layer of the printed circuit board while the eSATA port interface being located on a second outside layer of the printed circuit board. A terminal section is provided at the rear portion of the printed circuit board. The terminal section includes a plurality of connecting pads on the first outside layer or the second outside layer of the printed circuit board. The two interfaces are electrically connected with the connecting pads via a plurality of conducting traces. Accordingly, when a USB plug is inserted in the opening of the housing, electrical signal can be transmitted between the USB plug and a second printed circuit board electrically attached with the connecting pads; when an eSATA plug is inserted in the opening of the housing, electrical signal can be transmitted between the eSATA plug and a second printed circuit board electrically attached with the connecting pads.

Other objects, advantages, and novel features of the present invention will become more apparent from the following detailed description when taken in conjunction with the accompanying drawings.

### BRIEF DESCRIPTION OF THE DRAWINGS

FIG. 1 is a 3-dimensional view of a preferred embodiment according to the present invention.

FIG. 2 is another 3-dimensional view of the preferred embodiment according to the present invention.

FIG. 3 is a sectional view of the preferred embodiment according to the present invention.

FIG. 4 is a schematic view of the preferred embodiment according to the present invention, in which the terminal pins are bent downwardly.

FIG. 5 is a schematic view of the preferred embodiment according to the present invention, in which the terminal pins are bent upwardly.

FIG. 6 is a schematic view of the preferred embodiment according to the present invention, in which the terminal pins are each formed with double bends.

FIG. 7 is a schematic view of the preferred embodiment according to the present invention, in which the terminal pins are soldered to a second printed circuit board by surface mount technology.

FIG. 8 is a schematic view of the preferred embodiment according to the present invention, in which the terminal pins are soldered to a second printed circuit board by through-hole technology.

FIG. 9 is a schematic view of the preferred embodiment according to the present invention, in which the housing of the electronic connector is adapted to be mounted on a second printed circuit board.

FIG. 10 shows a layout of a first outside layer of a printed circuit board of the preferred embodiment according to the present invention

FIG. 11 shows a layout of a second outside layer of the printed circuit board of the preferred embodiment according to the present invention.

### DETAILED DESCRIPTION OF THE PREFERRED EMBODIMENTS

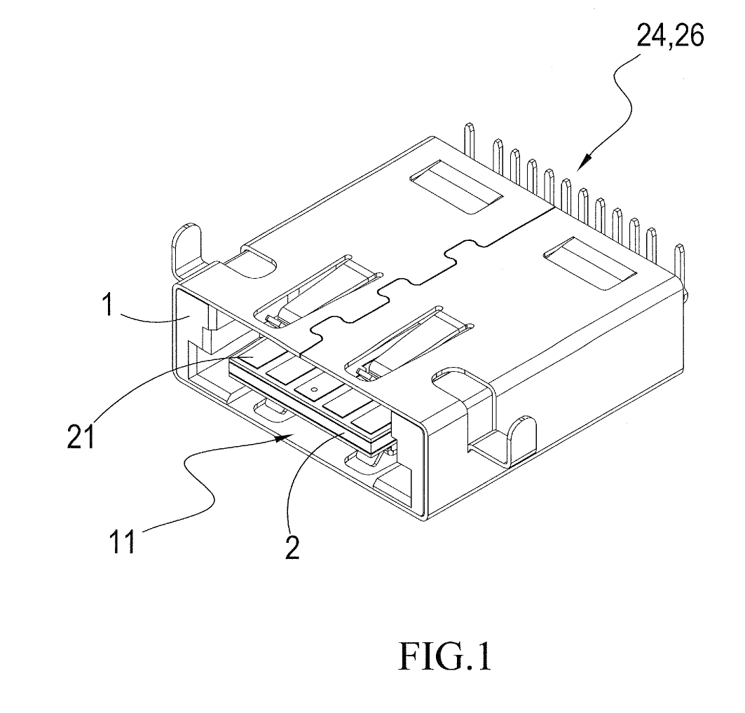

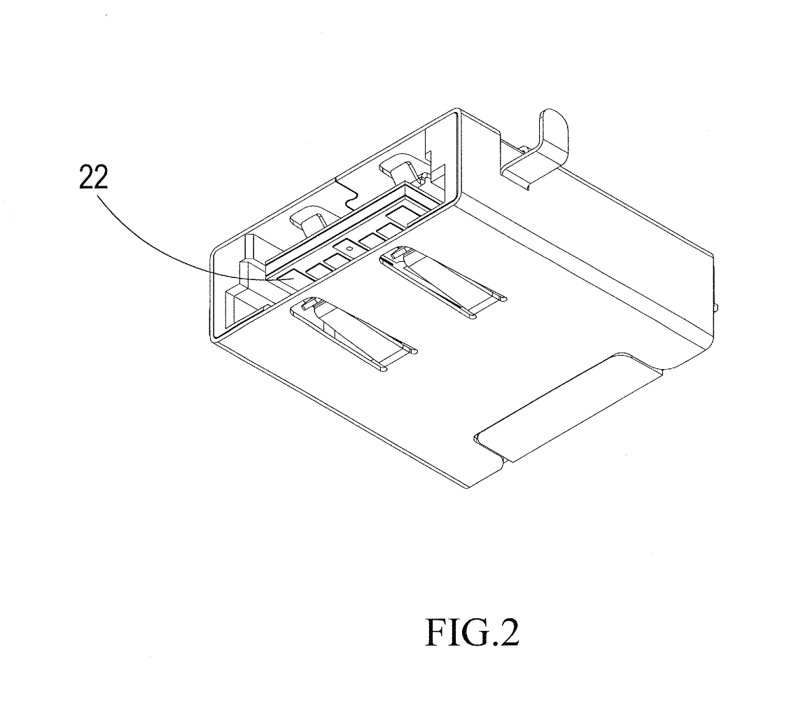

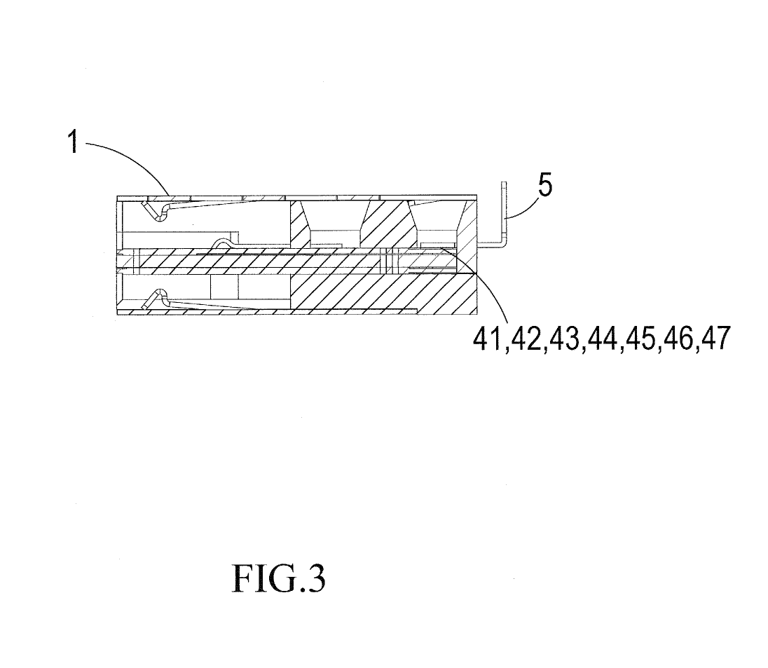

Turning now to FIGS. 1-3, a preferred embodiment according to the present invention generally comprises a housing 1 and a printed circuit board 2. The housing 1 defines an opening 11 therein. The printed circuit board 2 is mounted in the housing 1. The printed circuit board 2 has a front portion located within the opening 11 of the housing 1 and a rear portion attached to the housing 1. A USB3.0 port interface 21 and an eSATA port interface 22 is provided at the front portion of the printed circuit board 2. The USB3.0 port interface 21 is provided on a first outside layer of the printed circuit board 2 (for example, a top layer of the printed circuit board 2). The eSATA port interface 22 is provided on a second outside layer of the printed circuit board 2 (for example, a bottom layer of the printed circuit board 2).

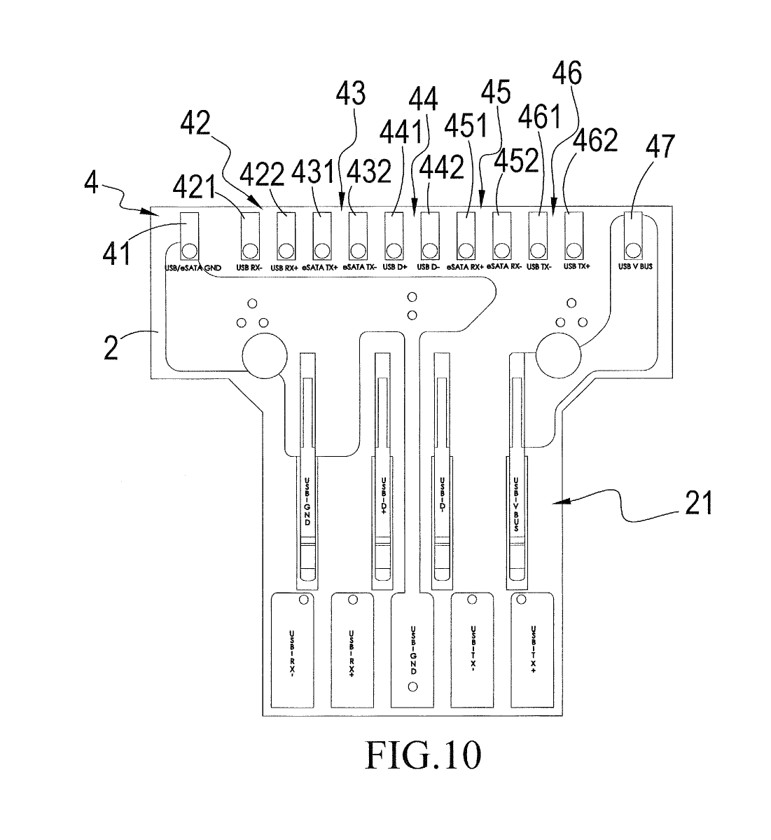

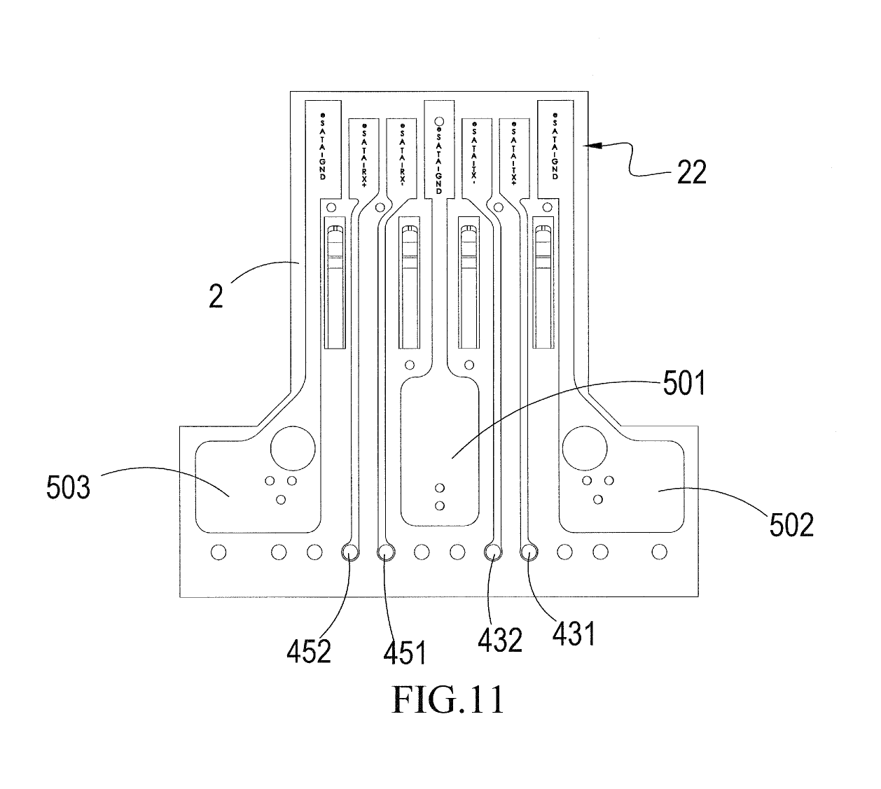

The USB3.0 port interface 21 is comprised of 9 contacts provided on the first outside layer of the printed circuit board 2. The eSATA port interface 22 is comprised of 7 contacts provided on the second outside layer of the printed circuit board 2. As can be seen in FIG. 10, the contacts of the USB3.0 port interface 21 are labeled with USB-RX−, USB-RX+, USB-GND, USB-TX−, USB-TX+(at front), USB-GND, USB-D+, USB-D−, USB-VBUS (at rear), in which the rear contacts are used for compatible with USB/USB2.0 standard. As can be seen in FIG. 11, the contacts of the eSATA port interface 22 are labeled with eSATA-GND, eSATA-TX+, eSATA-TX−, eSATA-GND, eSATA-RX−, eSATA-RX+, eSATA-GND.

As can be seen in FIG. 10, a terminal section 4 is provided at the rear portion of the printed circuit board 2 on the first outside layer of the printed circuit board 2. Alternatively, the terminal section 4 can be provided on the second outside layer of the printed circuit board 2. The terminal section 4 contains a plurality of connecting pads, which includes a ground pad 41, a USB receiving pad pair 42, an eSATA transmitting pad pair 43, a USB non-SuperSpeed pad pair 44, an eSATA receiving pad pair 45, a USB transmitting pad pair 46, and a power pad 47, wherein the pad or pad pair are arranged on the printed circuit board 2 in an order as the foregoing or in an order reversed to the foregoing.

As can be seen in FIGS. 10 and 11, the two interfaces 21, 22 are electrically connected with the connecting pads via a plurality of conducting traces, some of which are on the first or second outside layer of the printed circuit board 2 while some of which are on internal layers of the printed circuit board 2.

Furthermore, the ground contacts of the USB3.0 port interface 21 and the ground contacts of the eSATA port interface 22 can be combined to be electrically connected with the ground pad 41 (GND). The USB receiving pad pair 42 is composed of a positive-receiving signal pad 422 (USB-RX+) and a negative-receiving signal pad 421 (USB-RX−). The eSATA transmitting pad pair 43 is composed of a positive-transmitting signal pad 431 (eSATA-TX+) and a negative-transmitting signal pad 432 (eSATA-TX−). The USB non-SuperSpeed pad pair 44 is composed of a positive signal pad 441 (USB-D+) and a negative signal pad 442 (USB-D−). The eSATA receiving pad pair 45 is composed of a positive-receiving signal pad 451 (eSATA-RX−) and a negative-receiving signal pad 452 (eSATA-RX+). The USB transmitting pad pair 46 is composed of a positive-transmitting signal pad (USB-TX+) 462 and a negative-transmitting signal pad (USB-TX−) 461. The power contact of the USB3.0 port interface 21 is electrically connected with the power pad 47.

Preferably, the printed circuit board 2 is provided with terminal pins 5, each of which is electrically connected or soldered with one of the connecting pads at the terminal section 4, so that the contacts of the two interfaces 21, 22 are electrically connected with the terminal pins 5, which can be in turn soldered to a second printed circuit board to allow electrical signal to be further transmitted to the second circuit board.

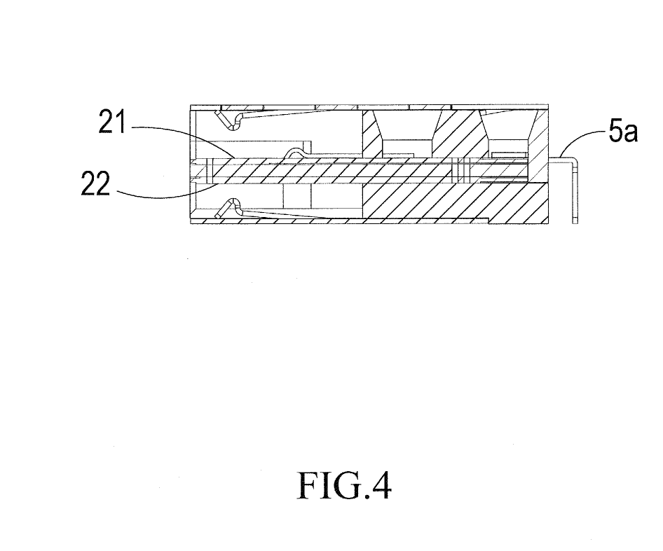

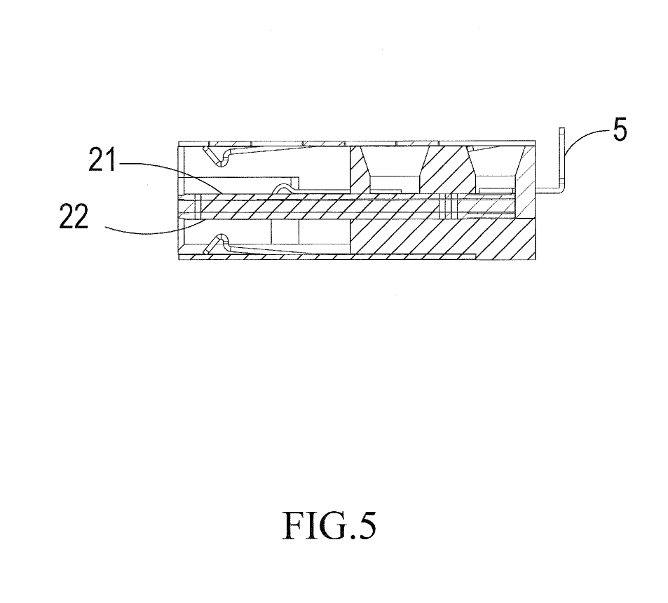

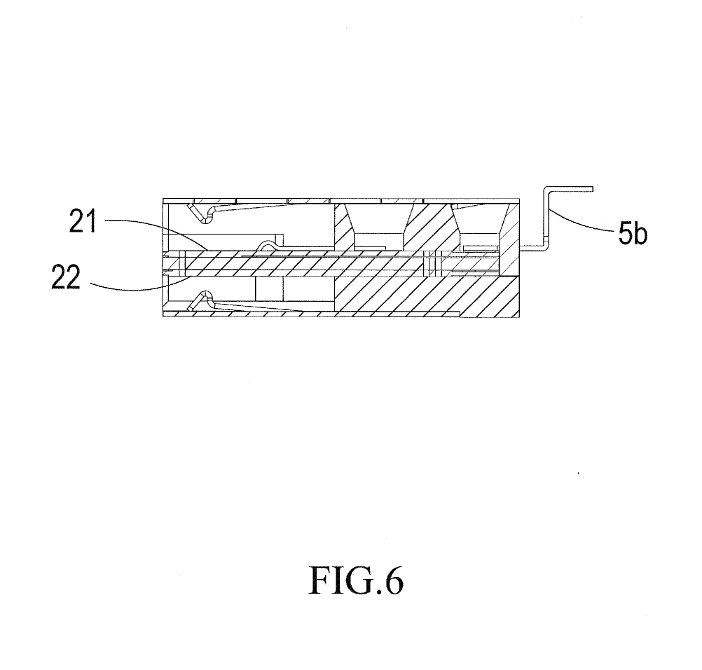

The terminal pins employed in the present invention can have any variations. For example, the terminal pins 5a of the printed circuit board 2 can be bent downwardly (see FIG. 4); the terminal pins 5 of the printed circuit board 2 can be bent upwardly (see FIG. 5); terminal pins 5b of the printed circuit board 2 can be each formed with double bends (see FIG. 6).

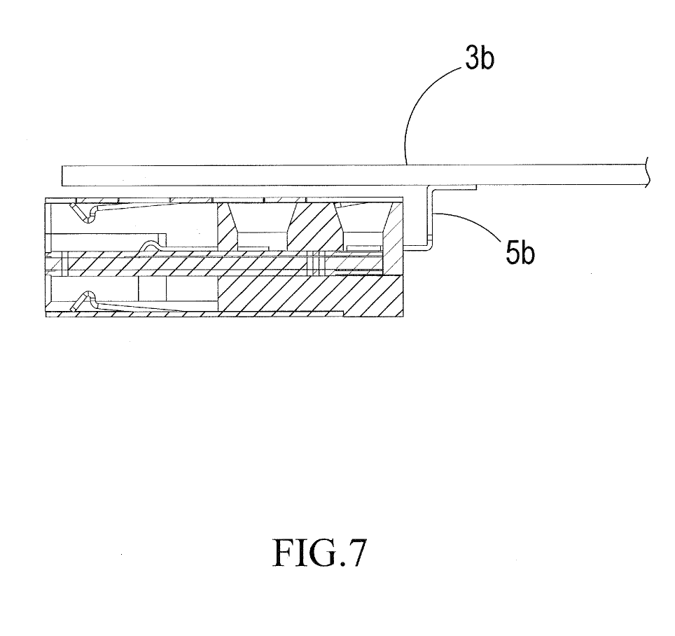

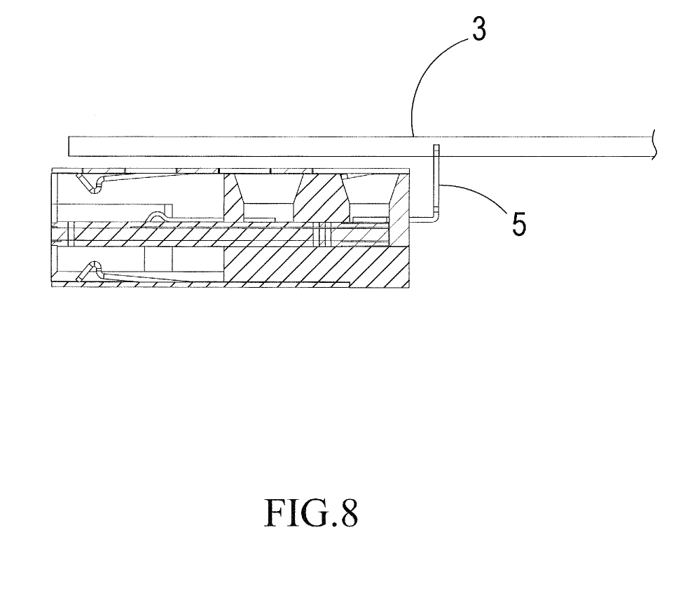

Furthermore, the terminal pins employed in the present invention can be soldered to a second printed circuit board by through-hole or surface mount technology. For example, the terminal pins 5b of the printed circuit board 2 can be soldered to a second printed circuit board 3b by surface mount technology (see FIG. 7); the terminal pins 5 of the printed circuit board 2 can be soldered to a second printed circuit board 3 by through-hole technology (see FIG. 8).

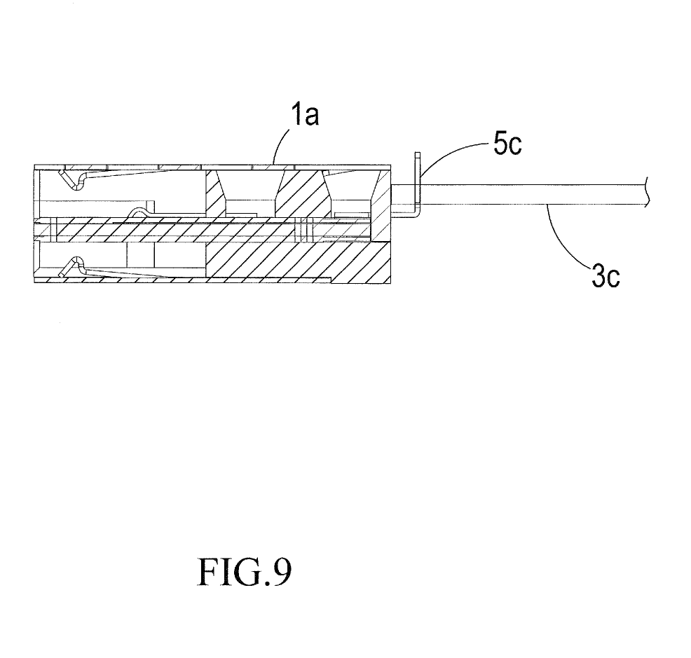

Alternatively, as shown in FIG. 9, a housing 1a can be adapted to be mounted on a second printed circuit board 3c, wherein the terminal pins 5c can be soldered to the second printed circuit board 3c by through-hole technology. However, the terminal pins 3c can be modified to allow them to be soldered on another printed circuit board by surface mount technology.

In operation, when a USB plug is inserted in the opening 11 of the housing 1, electrical signal can be transmitted between the USB plug and a second printed circuit board electrically attached with the terminal pins by way of the USB3.0 port interface and the corresponding terminal pins for USB; when an eSATA plug is inserted in the opening 11 of the housing 1, electrical signal can be transmitted between the eSATA plug and a second printed circuit board attached with the terminal pins by way of the eSATA port interface and the corresponding terminal pins for eSATA.

Furthermore, as can be seen in FIG. 11, a first grounded copper pour 501, a second grounded copper pour 502, and a third grounded pour 503 can be provided on the second outside layer of the printed circuit board 2 for the eSATA port interface 22. The first grounded copper pour 501 is located between a first pair of conducting traces electrically connected with the eSATA transmitting pad pair 431, 432 and a second pair of conducting traces electrically connected with the eSATA receiving pad pair 451, 452. The second grounded copper pour 502 is located at a side opposite to the first grounded copper pour 501 with respect to the first pair of conducting traces. The third grounded copper pour 503 is located at a side opposite to the first grounded copper pour 501 with respect to the second pair of conducting traces. The first, second, and third grounded copper pours 501, 502, 503 are employed to reduce electrical coupling between the pair of the eSATA transmitting pads 431, 432 and the pair of the eSATA receiving pads 451, 452.

Turning back to FIG. 10, regarding the USB communication, the USB differential signal pairs (USB-D+, USB-D−; USB-TX+, USB-TX−; USB-RX+, USB-RX−) are arranged to be isolated by the eSATA differential signal pair (eSATA-TX+, eSATA-TX−; eSATA-RX+, eSATA-RX−). This feature may further reduce electrical coupling between two USB differential signal pairs, so that the transmission distance for the USB signals can be increased. Regarding the eSATA communication, the eSATA differential signal pairs (eSATA-TX+, eSATA-TX−; eSATA-RX+, eSATA-RX−) are arranged to be isolated by the USB differential signal pair (USB-D+, USB-D−; USB-TX+, USB-TX−; USB-RX+, USB-RX−). This feature may further reduce electrical coupling between two eSATA differential signal pairs, so that the transmission distance for the eSATA signals can be increased.

Although the present invention has been described with a certain degree of particularity, it is understood that the present disclosure is made by way of example only and the combination and arrangement of parts may be resorted to without departing from the spirit and scope of the invention hereinafter claimed.

I claim:

1. An electronic connector comprising:
a housing defining an opening; and
a printed circuit board mounted in said housing, said printed circuit board having a front portion located within said opening of said housing and a rear portion attached to said housing;
wherein a USB3.0 port interface and an eSATA port interface are provided at said front portion of said printed circuit board, said USB3.0 port interface being located on a first outside layer of said printed circuit board while said eSATA port interface being located on a second outside layer of said printed circuit board; and
wherein a terminal section is provided at said rear portion of said printed circuit board and on said first outside layer or said second outside layer of said printed circuit board, said terminal section containing a plurality of connecting pads, said two interfaces being electrically connected with said connecting pads via a plurality of conducting traces;
whereby when a USB plug is inserted in said opening of said housing, electrical signal can be transmitted between said USB plug and a second printed circuit board electrically attached with said connecting pads; when an eSATA plug is inserted in said opening of said housing, electrical signal can be transmitted between said eSATA plug and a second printed circuit board electrically attached with said connecting pads.

2. The electronic connector of claim 1, wherein said USB3.0 port interface is comprised of contacts provided on said first outside layer of said printed circuit board, whereas said eSATA port interface is comprised of contacts provided on said second outside layer of said printed circuit board.

3. The electronic connector of claim 2, wherein said printed circuit board is provided with terminal pins, each of which is electrically connected with one of said connecting pads.

4. The electronic connector of claim 3, wherein said terminal pins are each bent downwardly or upwardly to be soldered to a second printed circuit board by through-hole technology.

5. The electronic connector of claim 3, wherein said terminal pins are each formed with double bends to be soldered to a second printed circuit board by surface mount technology.

6. The electronic connector of claim 3, wherein said housing is adapted to be mounted on a second printed circuit board, wherein said terminal pins can be soldered to a second printed circuit board by through-hole or surface mount technology.

7. The electronic connector of claim 3, wherein said connecting pads include a ground pad, a USB receiving pad pair, an eSATA transmitting pad pair, a USB non-SuperSpeed pad pair, an eSATA receiving pad pair, a USB transmitting pad pair, and a power pad, said connecting pad or pad pair are arranged on said printed circuit board in an order as the foregoing or in an order reversed to the foregoing; whereby USB differential signal pairs can be isolated by eSATA differential signal pairs, eSATA differential signal pairs can be isolated by USB differential signal pairs, so that electrical coupling can be reduced.

8. The electronic connector of claim 7, wherein ground contacts of said USB3.0 port interface and ground contacts of said eSATA port interface are combined to be electrically connected with the ground pad.

9. The electronic connector of claim 7, wherein the USB receiving pad pair is composed of a positive-receiving signal pad and a negative-receiving signal pad.

10. The electronic connector of claim 7, wherein the eSATA transmitting pad pair is composed of a positive-transmitting signal pad and a negative-transmitting signal pad.

11. The electronic connector of claim 7, wherein the USB non-SuperSpeed pad pair is composed of a positive signal pad and a negative signal pad.

12. The electronic connector of claim 7, wherein the eSATA receiving pad pair is composed of a positive-receiving signal pad and a negative-receiving signal pad.

13. The electronic connector of claim 7, wherein the USB transmitting pad pair is composed of a positive-transmitting signal pad and a negative-transmitting signal pad.

14. The electronic connector of claim 7, wherein a power contact of said USB3.0 port interface is electrically connected with the power pad.

15. The electronic connector of claim 7, wherein a first grounded copper pour, a second grounded copper pour, and a third grounded pour are provided on said second outside layer of said printed circuit board for said eSATA port interface, wherein said first grounded copper pour is located between a first pair of conducting traces electrically connected with the eSATA transmitting pad pair and a second pair of conducting traces electrically connected with the eSATA receiving pad pair, said second grounded copper pour is located at a side opposite to said first grounded copper pour with respect to the first pair of conducting traces, said third grounded copper pour is located at a side opposite to said first grounded copper pour with respect to the second pair of conducting traces; whereby electrical coupling between the two pairs of conducting traces can be reduced.

16. An electronic connector comprising:
a housing defining an opening; and
a printed circuit board mounted in said housing, said printed circuit board having a front portion located within said opening of said housing and a rear portion attached to said housing;
wherein a USB3.0 port interface and an eSATA port interface are provided at said front portion of said printed circuit board, said USB3.0 port interface being located on a first outside layer of said printed circuit board, said eSATA port interface being located on a second outside layer of said printed circuit board, said USB3.0 port interface being comprised of contacts provided on said first outside layer of said printed circuit board, said eSATA port interface being comprised of contacts provided on said second outside layer of said printed circuit board;
wherein a terminal section is provided at said rear portion of said printed circuit board and on said first outside layer or said second outside layer of said printed circuit board, said terminal section containing a plurality of connecting pads, said two interfaces being electrically connected with said connecting pads via a plurality of conducting traces; and
wherein said printed circuit board is provided with terminal pins, each of which is electrically connected with one of said connecting pads;
whereby when a USB plug is inserted in said opening of said housing, electrical signal can be transmitted between said USB plug and a second printed circuit board electrically attached with said connecting pads; when an eSATA plug is inserted in said opening of said housing, electrical signal can be transmitted between said eSATA plug and a second printed circuit board electrically attached with said connecting pads.

17. The electronic connector of claim 16, wherein said connecting pads include a ground pad, a USB receiving pad pair, an eSATA transmitting pad pair, a USB non-SuperSpeed pad pair, an eSATA receiving pad pair, a USB transmitting pad pair, and a power pad, said connecting pad or pad pair are arranged on said printed circuit board in an order as the foregoing or in an order reversed to the foregoing; whereby USB differential signal pairs can be isolated by eSATA differential signal pairs, eSATA differential signal pairs can be isolated by USB differential signal pairs, so that electrical coupling can be reduced.

18. The electronic connector of claim 17, wherein a first grounded copper pour, a second grounded copper pour, and a third grounded pour are provided on said second outside layer of said printed circuit board for said eSATA port interface, wherein said first grounded copper pour is located between a first pair of conducting traces electrically connected with the eSATA transmitting pad pair and a second pair of conducting traces electrically connected with the eSATA receiving pad pair, said second grounded copper pour is located at a side opposite to said first grounded copper pour with respect to the first pair of conducting traces, said third grounded copper pour is located at a side opposite to said first grounded copper pour with respect to the second pair of conducting traces; whereby electrical coupling between the two pairs of conducting traces can be reduced.
